(19) United States
(12) Patent Application Publication
(10) Pub. No.: US 2005/0073232 A1
(43) Pub. Date: Apr. 7, 2005

(54) Electron emitter

(75) Inventors: Yukihisa Takeuchi, Nishikamo-gun (JP); Tsutomu Nanataki, Toyoake-city (JP); Iwao Ohwada, Nagoya-city (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 10/678,958

(22) Filed: Oct. 3, 2003

(30) Foreign Application Priority Data
Oct. 3, 2003 (JP) NO. 2003-345992

(51) Int. Cl. H01J 1/05

(52) U.S. Cl. 313/311

(57) ABSTRACT

An electron emitter includes an emitter element made of a dielectric material, and an upper electrode and a lower electrode. A drive voltage is applied between the upper electrode and the lower electrode for emitting electrons from the emitter element. The upper electrode is formed on an upper surface of the emitter element, and the lower electrode is formed on a lower surface of the emitter element. The emitter element is exposed through a plurality of through regions of the upper electrode. Peripheral surfaces around the through regions facing the emitter element are spaced from the emitter element.

### BACKGROUND OF THE INVENTION

1. Field of the Invention

The present invention relates to an electron emitter having a first electrode and a second electrode which are formed on an emitter element.

2. Description of the Related Art

Recently, electron emitters having a cathode electrode and an anode electrode have been finding use in various applications such as field emission displays (FEDs) and backlight units. In an FED, a plurality of electron emitters are arranged in a two-dimensional array, and a plurality of phosphors are positioned in association with the respective electron emitters with a predetermined gap left therebetween.

Conventional electron emitters are shown in documents 1 through 5 enumerated below, for example. All of these disclosed electron emitters are disadvantageous in that since no dielectric body is employed as an emitter element, a forming process or a micromachining process is required between facing electrodes, a high voltage needs to be applied to emit electrons, and a panel fabrication process is complex and entails a high panel fabrication cost.

It has been considered to make an emitter of a dielectric material. The emission of electrons from a dielectric material has been discussed in documents 6 through 8 shown below.

[Document 1]

Japanese laid-open patent publication No. 1-311533

[Document 2]

Japanese laid-open patent publication No. 7-147131

[Document 3]

Japanese laid-open patent publication No. 2000-285801

[Document 4]

Japanese patent publication No. 46-20944

[Document 5]

Japanese patent publication No. 44-26125

[Document 6]

Yasuoka, Ishii “Pulsed electron source using a ferroelectric cathode”, J. Appl. Phys., Vol. 68, No. 5, p. 546-550 (1999)

[Document 7]

V. F. Puchkarev, G. A. Mesyats, “On the mechanism of emission from the ferroelectric ceramic cathode”, J. Appl. Phys., Vol. 78. No. 9, 1 Nov. 1995, p. 5633-5637

[Document 8]

H. Riege, Electron emission from ferroelectrics—a review”, Nucl. Instr. And Meth. A340, p. 80-89 (1994)

As shown in FIG. 22 of the accompanying drawings, in a conventional electron emitter 100, when an upper electrode 104 and a lower electrode 106 are formed on an emitter element 102, the upper electrode 104 may be formed in close contact with the emitter 102. An electric field concentration point, which is a triple point made up of the upper electrode 104, the emitter 102, and the vacuum, corresponds to a peripheral edge of the upper electrode 104.

Since the peripheral edge of the upper electrode 104 is in close contact with the emitter 104, the conventional electron emitter 100 is problematic in that the degree of electric field concentration is small and the energy required to emit electrons is small. Furthermore, inasmuch as the electron emission region is limited to the peripheral edge of the upper electrode 104, the overall electron emission characteristics suffer variations, making it difficult to control the emission of electrons and resulting in low electron emission efficiency.

### SUMMARY OF THE INVENTION

The present invention has been made in view of the above problems. It is an object of the present invention to provide an electron emitter which is capable of easily producing a high electric field concentration, increasing the number of electron emission regions, achieving high output and high efficiency for emitting electrons, and being driven at a low voltage.

An electron emitter according to the present invention has an emitter element made of a dielectric material, and a first electrode and a second electrode. A drive voltage is applied between the first electrode and the second electrode for emitting electrons from the emitter element. The first electrode is formed on a first surface of the emitter element, and the second electrode is formed on a second surface of the emitter element. At least the first electrode has a plurality of through regions. The emitter element is exposed through the through regions. The first electrode has a peripheral surface around each of the through regions. The peripheral surface faces the emitter element, and is spaced from the emitter element.

First, a drive voltage is applied between the first electrode and the second electrode. The drive voltage is defined as a voltage which, like a pulse voltage or an alternating voltage, changes sharply from a voltage level that is higher than a reference voltage (e.g., 0 V) to a voltage level that is lower than the reference voltage, or changes sharply from a voltage level that is lower than the reference voltage to a voltage level that is higher than the reference voltage level.

A triple junction is formed at a location where the first surface of the emitter element, the first electrode, and an ambient medium (e.g., vacuum) around the electron emitter contact each other. The triple junction is defined as an electric field concentration region that is formed by the contact between the first electrode, the emitter element, and the vacuum. The triple junction includes a triple point where the first electrode, the emitter element, and the vacuum are present at one point. According to the present invention, the triple junction is formed on peripheral edges of the through regions and peripheral portions of the first electrode. When the drive voltage is applied between the first electrode and the second electrode, an electric field concentration occurs at the triple junction.

A period for outputting the voltage level higher or lower than the reference voltage is referred to as a first output period, and a period for outputting the voltage level lower or higher than the reference voltage is referred to as a second output period. In the first output period, an electric field concentration in one direction occurs at the triple junction, accumulating electrons in those areas of the emitter element which correspond to the through regions of the first electrode and those areas of the emitter element which are positioned in the vicinity of the peripheral portions of the first electrode. At this time, the first electrode functions as an electron supply source.

When the voltage level of the drive voltage changes sharply in the second output period, a reverse electric field concentration occurs at the triple junction, causing electrons to be emitted through the through regions from the areas of the emitter element where the electrons have been accumulated. Electrons are also emitted from the emitter element near the outer peripheral portions of the first electrode.

According to another electron emission process, in a first output period, the electron emitter is prepared for the emission of electrons (e.g., the emitter element is polarized in one direction). When the voltage level of the drive voltage changes sharply in a next second output period, an electric field concentration occurs at the triple junction, causing primary electrons to be emitted from the first electrode. The primary electrons impinge upon the areas of the emitter element which are exposed through the through regions and the areas of the emitter element which are positioned in the vicinity of the outer peripheral portions of the first electrode. Secondary electrons (including reflected ones of the primary electrons) are emitted from the areas of the emitter element with which the primary electrons have collided. Thus, in an initial stage of the second output period, secondary electrons are emitted from the emitter element through the through regions and near the outer peripheral portions of the first electrode.

With the electron emitter, since the plural through regions are formed in the first electrode, electrons are uniformly emitted from the emitter element through the through regions and near the outer peripheral portions of the first electrode. Any variations in the overall electron emission characteristics of the electron emitter are reduced, allowing easy control over the emission of electrons and increasing electron emission efficiency.

According to the present invention, since a gap is defined between the emitter element and the peripheral surface around each of the through regions of the first electrode which faces the emitter element, when the drive voltage is applied, an electric field concentration can easily occur at the gap. This leads to an increase in the electron emission efficiency and a reduction in the drive voltage, i.e., an emission of electrons at a lower voltage level.

According to the present invention, as described above, because the gap is defined between the emitter element and the peripheral surface around each of the through regions of the first electrode which faces the emitter element, the peripheral surface around each of the through regions has an eave (a flange) shape. Since a greater electric field concentration occurs at the gap, it is easy for electrons to be emitted from the eave (the peripheral surface of the through region). This leads to higher output and higher efficiency for the emission of electrons, and lower levels for the drive voltage. According to either the process for emitting electrons accumulated in the emitter element or the process for emitting secondary electrons by having primary electrons from the first electrode impinge upon the emitter element, since the peripheral surface around each of the through regions of the first electrode functions as a gate electrode (a control electrode, a focusing electronic lens, or the like), the straightness of emitted electrons can be increased. The improved straightness of emitted electrons is advantageous in reducing crosstalk in a system where a number of electron emitters are arrayed for use as an electron source for a display apparatus, for example.

According to the present invention, as described above, the electron emitter is easily capable of producing high electric field concentrations. The electron emitter is also capable of increasing the number of electron emission regions, achieving high output and high efficiency for emitting electrons, and being driven at a low voltage (low power consumption).

In the above arrangement, at least the first surface of the emitter element has an uneven surface (irregularities) defined by grain boundaries of a dielectric material. The through regions of the first electrode are formed at positions corresponding to recesses of the uneven surface.

Consequently, it is easily possible to provide a structure in which the peripheral surface around each of the through regions of the first electrode which faces the emitter element is spaced from the emitter element, i.e., the gap is defined between the emitter element and the peripheral surface around each of the through regions of the first electrode which faces the emitter element.

In the above arrangement, a maximum angle θ formed between the first surface of the emitter element and the peripheral surface around each of the through regions facing the emitter element is preferably in the range of 1°≦θ≦60°. In the above arrangement, a maximum distance d in a vertical direction between the first surface of the emitter element and the peripheral surface around each of the through regions facing the emitter element is preferably in the range of 0 μm<d≦10 μm. With these structures, the degree of an electric field concentration at the gap is made greater for achieving high output and high efficiency for emitting electrons and lowering the drive voltage.

In the above arrangement, floating electrodes may be present on the first surface of the emitter element, at positions corresponding to the through regions. Since the floating electrodes serve as an electron supply source, the electron emitter can emit many electrons through the through regions in an electron emission stage (the second output period described above).

In the above arrangement, the through regions may comprise holes. Portions of the emitter element whose polarization is reversed or changed depending on the drive voltage that is applied between the first electrode and the second electrode include portions (first portions) directly below the first electrode, and portions (second portions) corresponding to regions extending from inner peripheral edges of the through regions inwardly into the through regions. Particularly, the second portions change depending on the level of the drive voltage and the degree of the electric field concentration. According to the present invention, the average diameter of the holes should preferably be in the range from 0.1 μm to 10 μm. As long as the average diameter falls in the above range, a distribution of electrons emitted through the through regions is almost free of variations, allowing electrons to be emitted efficiently.

If the average diameter of the holes is less than 0.1 μm, then the regions where electrons are accumulated are reduced, and the amount of emitted electrons is also reduced. While one solution would be to form many holes, it would be difficult and costly to form many holes. If the average diameter of the holes exceeds 10 μm, then the proportion (share) of the portions (second portions) which contribute to the emission of electrons, of those areas of the emitter element which are exposed through the through regions, is reduced, resulting in a reduction in the efficiency with which to emit electrons.

In the above arrangement, the through regions may comprise notches or comb-toothed notches. The notches should preferably have an average width ranging from 0.1 μm to 10 μm.

In the above arrangement, the through regions may comprise slits having an arbitrary shape. The slits should preferably have an average width ranging from 0.1 μm to 10 μm.

Another electron emitter according to the present invention comprises an emitter element made of a dielectric material, a first electrode formed in contact with a first surface of the emitter element, and a second electrode formed in contact with a second surface of the emitter element. At least the first electrode has a plurality of through regions, and the emitter element is exposed through the through regions. The emitter element produces an electrical capacitor, and the through regions of the first electrode produce a cluster of plural electrical capacitors between the first electrode and the emitter element.

Specifically, a gap is defined between the emitter element and the peripheral surface around each of the through regions which faces the emitter element, and a cluster of capacitors is formed by the gaps. The capacitance of the cluster of the capacitors provided by the gaps is relatively small, and because of the voltage division between the capacitors formed by the gaps and the capacitor provided by the emitter element, most of the voltage is applied across the gaps, achieving higher output for emitting electrons at the gaps. The capacitor provided by the cluster of the capacitors is connected in series to the capacitor provided by the emitter element. Therefore, the overall capacitance is smaller than the capacitance of the capacitor provided by the emitter element. Accordingly, the electron emitter provides such preferable characteristics that it emits electrons at high output and has reduced overall power consumption.

As described above, the electron emitter according to the present invention is capable of easily producing a high electric field concentration, increasing the number of electron emission regions, achieving high output and high efficiency for emitting electrons, and being driven at a low voltage (low power consumption).

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a fragmentary cross-sectional view of an electron emitter according to a first embodiment of the present invention;

FIG. 2 is an enlarged fragmentary cross-sectional view of the electron emitter according to the first embodiment;

FIG. 3 is a plan view showing by way of example the configuration of through regions formed in an upper electrode;

FIG. 4 is a diagram showing the waveform of a drive voltage according to a first electron emission process;

FIG. 5 is a view illustrative of the manner in which electrons are emitted in a second output period according to the first electron emission process;

FIG. 6 is a diagram showing the waveform of a drive voltage according to a second electron emission process;

FIG. 7 is a view illustrative of the manner in which electrons are emitted in a second output period according to the second electron emission process;

FIG. 8 is a view showing a cross-sectional shape of an eave of an upper electrode;

FIG. 9 is a view showing another cross-sectional shape of an eave of an upper electrode;

FIG. 10 is a view showing still another cross-sectional shape of an eave of an upper electrode;

FIG. 11 is an equivalent circuit diagram showing various capacitors that are connected between upper and lower electrodes;

FIG. 12 is a diagram illustrative of the manner in which the capacitances of the various capacitors that are connected between the upper and lower electrodes are calculated;

FIG. 13 is a fragmentary plan view of a first modification of the electron emitter according to the first embodiment;

FIG. 14 is a fragmentary plan view of a second modification of the electron emitter according to the first embodiment;

FIG. 15 is a plan view of a third modification of the electron emitter according to the first embodiment;

FIG. 16 is a fragmentary cross-sectional view of an electron emitter according to a second embodiment of the present invention;

FIG. 17 is a fragmentary cross-sectional view of a first modification of the electron emitter according to the second embodiment;

FIG. 18 is a fragmentary cross-sectional view of a second modification of the electron emitter according to the second embodiment;

FIG. 19 is a fragmentary cross-sectional view of a third modification of the electron emitter according to the second embodiment;

FIG. 20 is a fragmentary cross-sectional view of an electron emitter according to a third embodiment of the present invention;

FIG. 21 is a fragmentary cross-sectional view of a first modification of the electron emitter according to the third embodiment; and

FIG. 22 is a fragmentary cross-sectional view of a conventional electron emitter.

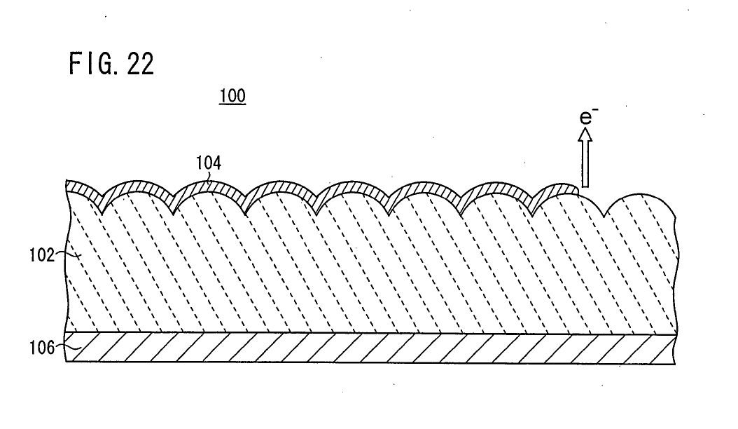

### DESCRIPTION OF THE PREFERRED EMBODIMENTS

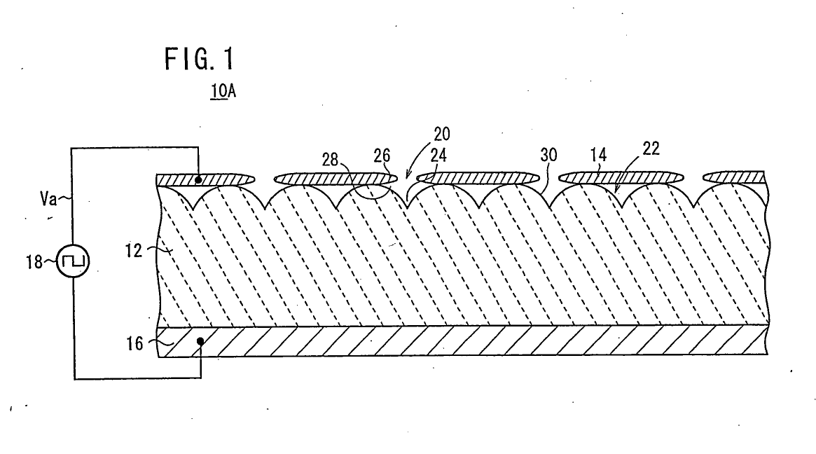

Embodiments of electron emitters according to the present invention will be described below with reference to FIGS. 1 through 21.

Light emission devices according to the present invention can be used in displays, electron beam irradiation apparatus, light sources, alternatives to LEDs, and electronic parts manufacturing apparatus.

An electron beam in an electron beam irradiation apparatus has a higher energy and a better absorption capability than ultraviolet rays in ultraviolet ray irradiation apparatus that are presently in widespread use. Light emission devices are used to solidify insulating films in superposing wafers for semiconductor devices, harden printing inks without irregularities for drying prints, and sterilize medical devices while being kept in packages.

The electron emitters are also used as high-luminance, high-efficiency light sources such as a projector having a high pressure mercury lamp. The electron emitter according to the present embodiment is suitably used as a light source. The light source using the electron emitter according to the present embodiment is compact, has a long service life, has a fast response speed for light emission. The electron emitter does not use any mercury, and the electron emitter is environmentally friendly.

The electron emitters are also used as alternatives to LEDs in indoor lights, automobile lamps, surface light sources for traffic signal devices, chip light sources, and backlight units for traffic signal devices, small-size liquid-crystal display devices for cellular phones.

The electron emitters are also used in apparatus for manufacturing electronic parts, including electron beam sources for film growing apparatus such as electron beam evaporation apparatus, electron sources for generating a plasma (to activate a gas or the like) in plasma CVD apparatus, and electron sources for decomposing gases. The electron emitters are also used as vacuum micro devices such as high speed switching devices operated at a frequency on the order of Tera-Hz, and large current outputting devices. Further, the electron emitter are used suitably as parts of printers, such as light emitting devices for emitting light to a photosensitive drum, and electron sources for charging a dielectric material.

The electron emitters are also used as electronic circuit devices including digital devices such as switches, relays, and diodes, and analog devices such as operational amplifiers. The electron emitters are used for realizing a large current output, and a high amplification ratio.

As shown in FIG. 1, an electron emitter 10A according to a first embodiment of the present invention has a plate-like emitter element 12 made of a dielectric material, a first electrode (e.g., an upper electrode) 14 formed on a first surface (e.g., an upper surface) of the emitter element 12, a second electrode (e.g., a lower electrode) 16 formed on a second surface (e.g., a lower surface) of the emitter element 12, and a pulse generation source 18 for applying a drive voltage Va between the upper electrode 14 and the lower electrode 16.

The upper electrode 14 has a plurality of through regions 20 through which the emitter element 12 is exposed. In particular, the emitter element 12 has surface irregularities (uneven surface) 22 defined by grain boundaries of the dielectric material. The through regions 20 of the upper electrode 14 corresponds to recesses 24 of the surface irregularities 22 that are produced by grain boundaries of the dielectric material. In the embodiment shown in FIG. 1, one through region 20 corresponds to one recess 24. However, one through region 20 may be correspond to a plurality of recesses 24. The dielectric material of the emitter element 12 has particle diameters preferably ranging from 0.1 μm to 10 μm, or more preferably from 2 μm to 7 μm. In the embodiment shown in FIG. 1, the particle diameter of the dielectric material is 3 μm.

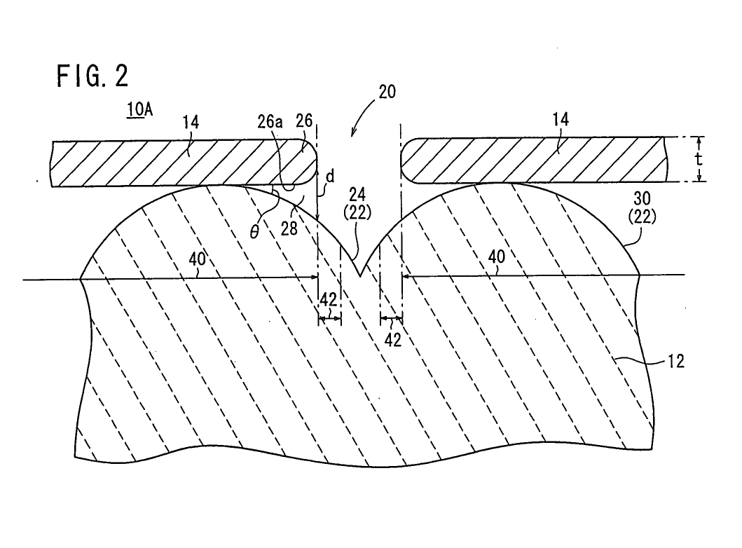

With the electron emitter 10A, as shown in FIG. 2, each of the through regions 20 of the upper electrode 14 includes a peripheral edge 26 having a surface 26a facing and spaced from the emitter element 12. Specifically, a gap 28 is defined between emitter element 12 and the surface 26a of the peripheral edge 26 which faces the emitter element 12, and the peripheral edge 26 of each of the through regions 20 is shaped as an eave (a flange). In the description which follows, the peripheral edge 26 of each of the through regions 20 of the upper electrode 14 will be referred to as the eave 26 of the upper electrode 14. In FIGS. 1, 2, 5, 7, 8 through 10, and 15, lands 30 of the surface irregularities 22 produced by the grain boundaries of the dielectric material are shown as having a semicircular cross-sectional shape, but are not limited to such a cross-sectional shape.

With the electron emitter 10A, the upper electrode 14 has a thickness t in the range of 0.01 μm≦t≦10 μm, and a maximum angle θ formed between the upper surface of the emitter element 12, i.e., the surface of each of the lands 30 (the inner wall surface of each of the recesses 24) produced by the grain boundaries of the dielectric material, and the lower surface 26a of the eave 26 of the upper electrode 14 is in the range of 1°≦θ≦60°. Furthermore, a maximum distance d in the vertical direction between the surface of each of the lands 30 (the inner wall surface of each of the recesses 24) produced by the grain boundaries of the dielectric material of the emitter element 12 and the lower surface 26a of the eave 26 of the upper electrode 14 is in the range of 0 μm<d≦10 μm.

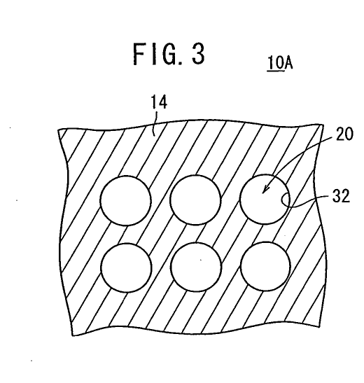

With the electron emitter 10A, moreover, the shape of each of the through regions 20, particularly the shape as viewed from above, as shown in FIG. 3, is the same as the shape of a hole 32, which may be a circular shape, an elliptical shape, a track shape, a shape including a curved portion, or a polygonal shape such as a rectangular shape or a triangular shape. In the embodiment shown in FIG. 3, the shape of the hole 32 is a circular shape.

The holes 32 have an average diameter ranging from 0.1 μm to 10 μm. The average diameter represents the average of the lengths of a plurality of different line segments that pass through the center of the hole 32.

The materials, etc. of the components of the light emission device will be described below. The dielectric material of the emitter element 12 should preferably have a relatively high dielectric constant, e.g., a dielectric constant of 1000 or higher. Dielectric materials of such a nature may be ceramics including barium titanate, lead zirconate, lead magnesium niobate, lead nickel niobate, lead zinc niobate, lead manganese niobate, lead magnesium tantalate, lead nickel tantalate, lead antimony tinate, lead titanate, lead magnesium tungstenate, lead cobalt niobate, etc., ceramics containing a desired combination of these compounds, materials whose chief constituent contains 50 weight % or more of these compounds, or materials containing the above ceramics and oxides of lanthanum, calcium, strontium, molybdenum, tungsten, barium, niobium, zinc, nickel, manganese, etc., any combinations thereof, or other compounds added thereto.

For example, a two-component nPMN-mPT compound (n, m represent molar ratios) of lead magnesium niobate (PMN) and lead titanate (PT) has its Curie point lowered and its specific dielectric constant increased at room temperature when the molar ratio of PMN is increased.

Particularly, if n=0.85−1.0, m=1.0−n, then the specific dielectric constant has a preferable value of 3000 or higher. For example, if n=0.91, m=0.09, then the specific dielectric constant of 15000 at room temperature is achieved, and if n=0.95, m=0.05, the specific dielectric constant of 20000 at room temperature is achieved.

A three-component compound of lead magnesium niobate (PMN), lead titanate (PT), and lead zirconate (PZ) may have its specific dielectric constant increased preferably by making the compound have a composition in the vicinity of a morphotropic phase boundary (MPB) between a tetragonal system and a pseudo-cubic system or a tetragonal system and a rhombohedral system, other than increasing the molar ratio of PMN. For example, the specific dielectric constant of 5500 is achieved preferably with PMN:PT:PZ=0.375:0.375:0.25, and the specific dielectric constant of 4500 is achieved preferably with PMN:PT:PZ=0.5:0.375:0.125. It is also preferable to increase the dielectric constant by mixing the above dielectric materials with a metal such as platinum insofar as electric insulation is maintained. For example, the dielectric materials are mixed with 20 weight % of platinum.

The emitter element 12 may be in the form of a piezoelectric/electrostrictive layer or an anti-ferroelectric layer, as described above. If the emitter element 12 comprises a piezoelectric/electrostrictive layer, then it may be made of ceramics such as lead zirconate, lead magnesium niobate, lead nickel niobate, lead zinc niobate, lead manganese niobate, lead magnesium tantalate, lead nickel tantalate, lead antimony tinate, lead titanate, barium titanate, lead magnesium tungstenate, lead cobalt niobate, or the like or a combination of any of these materials.

The emitter element 12 may be made of chief components including 50 weight % or more of any of the above compounds. Of the above ceramics, the ceramics including lead zirconate is most frequently used as a constituent of the piezoelectric/electrostrictive layer of the emitter element 12.

If the piezoelectric/electrostrictive layer is made of ceramics, then oxides of lanthanum, calcium, strontium, molybdenum, tungsten, barium, niobium, zinc, nickel, manganese, or the like, or a combination of these materials, or any of other compounds may be added to the ceramics. Ceramics produced by adding SiO₂, CeO₂, Pb₅Ge₃O₁₁, or a combination of any of these compounds to the above ceramics may be employed. Specifically, a material produced by adding 0.2 wt % of SiO₂, or 0.1 wt % of CeO₂, or 1-2 wt % of Pb₅Ge₃O₁₁ to a PT-PZ-PMN piezoelectric material is preferable.

For example, the piezoelectric/electrostrictive layer should preferably be made of ceramics including as chief components lead magnesium niobate, lead zirconate, and lead titanate, and also including lanthanum and strontium.

The piezoelectric/electrostrictive layer may be dense or porous. If the piezoelectric/electrostrictive layer is porous, then it should preferably have a porosity of 40% or less.

If the emitter element 12 is in the form of an anti-ferroelectric layer, then the anti-ferroelectric layer may be made of lead zirconate as a chief component, lead zirconate and lead stannate as chief components, lead zirconate with lanthanum oxide added thereto, or lead zirconate and lead stannate as components with lead zirconate and lead niobate added thereto.

The anti-ferroelectric layer may be porous. If the anti-ferroelectric layer is porous, then it should preferably have a porosity of 30% or less.

If the emitter element 12 is made of strontium tantalate bismuthate (SrBi₂Ta₂O₉), then its polarization reversal fatigue is small and preferable. Materials whose polarization reversal fatigue is small are laminar ferroelectric compounds and expressed by the general formula of (BiO₂)²⁺(Aₘ₋₁BₘO₃ₘ₊₁)²⁻. Ions of the metal A are Ca²⁺, Sr²⁺, Ba²⁺, Pb²⁺, Bi³⁺, La³⁺, etc., and ions of the metal B are Ti⁴⁺, Ta⁵⁺, Nb⁵⁺, etc.

The baking temperature can be lowered by adding glass such as lead borosilicate glass or the like or other compounds of low melting point (e.g., bismuth oxide or the like) to the piezoelectric/electrostrictive/anti-ferroelectric ceramics.

If the emitter element 12 is made of piezoelectric/electrostrictive/anti-ferroelectric ceramics, then it may be molded as a sheet, laminated as a sheet, or laminated on or bonded to another support board.

If the emitter element 12 is made of a material having a high melting point or a high evaporation temperature, such as a non-lead material, then it is made resistant to damage caused by collision with electrons or ions.

The upper electrode 14 is made of a material such as an organic metal paste which can produce a thin film after being baked. For example, a platinum resinate paste or the like, should preferably be used. An oxide electrode for suppressing a polarization reversal fatigue, which is made of ruthenium oxide (RuO₂), iridium oxide (IrO₂), strontium ruthenate (SrRuO₃), La₁₋ₓSrₓCoO₃ (e.g., x=0.3 or 0.5), La₁₋ₓCaₓMnO₃ (e.g., x=0.2), La₁₋ₓCaₓMn_{1-y}Co_{y}O₃ (e.g., x=0.2, y=0.05), or a mixture of any one of these compounds and a platinum resinate paste, for example, is preferable.

The upper electrode 14 may be made of any of the above materials by any of various thick-film forming processes including screen printing, spray coating, coating, dipping, electrophoresis, etc., or any of various thin-film forming processes including sputtering, an ion beam process, vacuum evaporation, ion plating, chemical vapor deposition (CVD), plating, etc. Preferably, the upper electrode 14 is made by any of the above thick-film forming processes.

The lower electrode 16 is made of platinum, molybdenum, tungsten, etc. The lower electrode 16 may be made of a conductor which is resistant to a high-temperature oxidizing atmosphere, e.g., a metal, an alloy, a mixture of insulative ceramics and a metal, or a mixture of insulative ceramics and an alloy. Preferably, the lower electrode 16 should be chiefly composed of a precious metal having a high melting point, e.g., platinum, iridium, palladium, rhodium, molybdenum, or the like, or an alloy of silver and palladium, silver and platinum, platinum and palladium, or the like, or a cermet of platinum and ceramics. Further preferably, the lower electrode 16 should be made of platinum only or a material chiefly composed of a platinum-base alloy.

The lower electrode 16 should also preferably be made of carbon or a graphite-base material. Ceramics to be added to the electrode material should preferably have a proportion ranging from 5 to 30 volume %. The lower electrode 16 may be made of the same material as the upper electrode described above.

The lower electrode 16 is preferably made by any of the above thick-film forming processes. The lower electrode 16 has a thickness of 20 μm or less and preferably 5 μm or less.

Each time the emitter element 12, the upper electrode 14, or the lower electrode 16 is formed, the assembly may be heated (sintered) into an integral structure.

The sintering process for integrally combining the emitter element 12, the upper electrode 14, and the lower electrode 16 may be carried out at a temperature ranging from 500 to 1400° C., preferably from 1000 to 1400° C. For heating the emitter element 12 which is in the form of a film, the emitter element 12 should be sintered together with its evaporation source while their atmosphere is being controlled, so that the composition of the emitter element 12 will not become unstable at the high temperature.

By baking the assembly, the film which will serves as the upper electrode 14 shrinks from a thickness of 10 μm to a thickness of 0.1 μm, and simultaneously a plurality of holes are formed therein. As a result, as shown in FIG. 1, the plural through regions 20 are formed in the upper electrode 14, with their peripheral edges 26 shaped into eaves. The film which will serves as the upper electrode 14 may be patterned in advance (prior to baking) by etching (wet etching or dry etching), lift-off, or the like, and then baked. This process allows the through regions 20 to be easily shaped as cut-outs or slits, as described later on.

The emitter element 12 may be covered with an appropriate member and then baked, so that the surface thereof will be concealed against direct exposure to the sintering atmosphere when the emitter element 12 is sintered.

The principles by which the electron emitter 10A operates to emit electrons will be described below. First, a drive voltage Va is applied between the upper electrode 14 and the lower electrode 16. The drive voltage Va is defined as a voltage which, like a pulse voltage or an alternating voltage, changes sharply from a voltage level that is higher or lower than a reference voltage (e.g., 0 V) to a voltage level that is lower or higher than the reference voltage.

A triple junction is formed at a location where the upper surface of the emitter element 12, the upper electrode 14, and an ambient medium (e.g., vacuum) around the electron emitter 10A contact each other. The triple junction is defined as an electric field concentration region that is formed by the contact between the upper electrode 14, the emitter element 12, and the vacuum. The triple junction includes a triple point where the upper electrode 14, the emitter element 12, and the vacuum are present at one point. The vacuum level in the atmosphere should preferably in the range from 10² to 10⁻⁶ Pa and more preferably in the range from 10⁻³ to 10⁻⁵ Pa.

On the electron emitter 10A, the triple junction is formed on the eaves 26 of the upper electrode 14 and the peripheral portions of the upper electrode 14. When the drive voltage Va is applied between the upper electrode 14 and the lower electrode 16, an electric field concentration occurs at the triple junction.

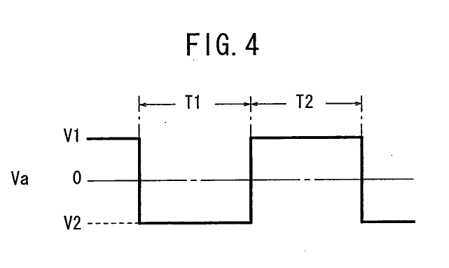

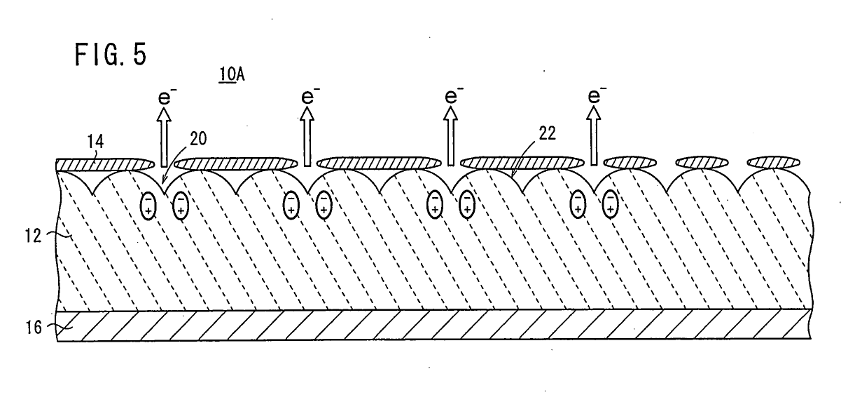

A first electron emission process will be described below with reference to FIGS. 4 and 5. In a first output period T1 shown in FIG. 4, a voltage V2 lower than a reference voltage (0 V in FIG. 4) is applied to the upper electrode 14, and a voltage V1 higher than the reference voltage is applied to the lower electrode 16. In the first output period T1, an electric field concentration occurs at the triple junction, accumulating electrons in those areas of the emitter element 12 which are exposed through the through regions 20 of the upper electrode 14 and those areas of the emitter element 12 which are positioned in the vicinity of the peripheral portions of the upper electrode 14. At this time, the upper electrode 14 functions as an electron supply source.

In a next second output period T2, the voltage level of the drive voltage V2 changes sharply. That is, the voltage V1 higher than the reference voltage is applied to the upper electrode 14, and the voltage V2 lower than the reference voltage is applied to the lower electrode 16. Now, a reverse electric field concentration occurs at the triple junction, causing electrons to be emitted through the through regions 20 from the areas of the emitter element 12 where the electrons have been accumulated, as shown in FIG. 5. Electrons are also emitted from the emitter element 12 near the outer peripheral portions of the upper electrode 14.

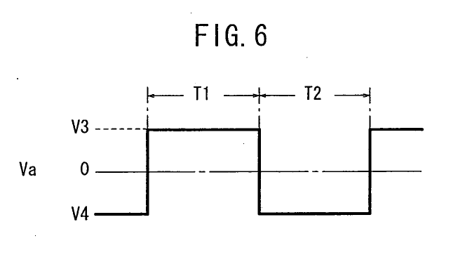

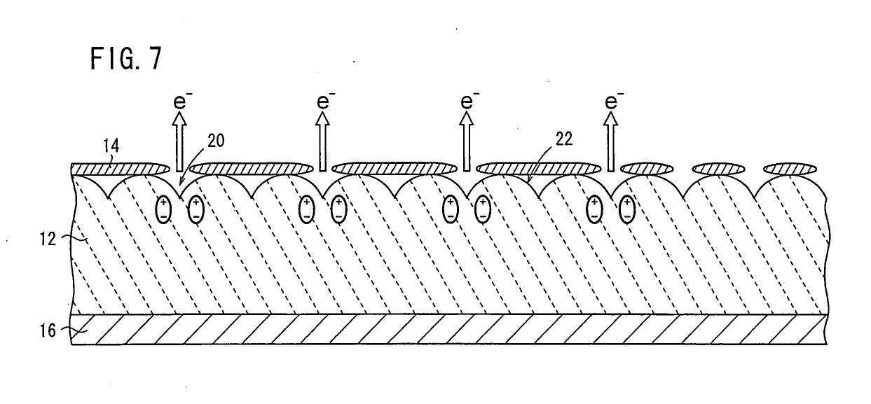

A second electron emission process will be described below with reference to FIGS. 6 and 7. In a first output period T1 shown in FIG. 6, a voltage V3 higher than the reference voltage is applied to the upper electrode 14, and a voltage V4 lower than the reference voltage is applied to the lower electrode 16. In the first output period T1, the electron emitter 10A is prepared for the emission of electrons (e.g., the emitter element 12 is polarized in one direction). In a next second output period T2, the voltage level of the drive voltage V2 changes sharply. That is, the voltage V4 lower than the reference voltage is applied to the upper electrode 14, and the voltage V3 higher than the reference voltage is applied to the lower electrode 16. Now, an electric field concentration occurs at the triple junction, causing primary electrons to be emitted from the upper electrode 14. The primary electrons impinge upon the areas of the emitter element 12 which are exposed through the through regions 20 and the areas of the emitter element 12 which are positioned in the vicinity of the outer peripheral portions of the upper electrode 14. As shown in FIG. 7, secondary electrons (including reflected ones of the primary electrons) are emitted from the areas of the emitter element 12 with which the primary electrons have collided. Thus, in an initial stage of the second output period T2, secondary electrons are emitted from the emitter element 12 through the through regions 20 and near the outer peripheral portions of the upper electrode 14.

With the electron emitter 10A, since the plural through regions 20 are formed in the upper electrode 14, electrons are uniformly emitted from the emitter element 12 through the through regions 20 and near the outer peripheral portions of the upper electrode 14. Any variations in the overall electron emission characteristics of the electron emitter 10A are reduced, allowing easy control over the emission of electrons and increasing electron emission efficiency.

With the electron emitter 10A, since the gap 28 is defined between the eave 26 of the upper electrode 14 and the emitter element 12, when the drive voltage Va is applied, an electric field concentration can easily occur at the gap 28. This leads to an increase in the electron emission efficiency and a reduction in the drive voltage, i.e., an emission of electrons at a lower voltage level.

With the electron emitter 10A, as described above, because the eave 26 is formed around each of the through regions 20 of the upper electrode 14, and also because a greater electric field concentration occurs at the gap 28, it is easy for electrons to be emitted from the eave 26 of the upper electrode 14. This leads to higher output and higher efficiency for the emission of electrons, and lower levels for the drive voltage V1. According to either the first electron emission process (for emitting electrons accumulated in the emitter element 12) or the second electron emission process (for emitting secondary electrons by having primary electrons from the upper electrode 14 impinge upon the emitter element 12), since the eave 26 of the upper electrode 14 functions as a gate electrode (a control electrode, a focusing electronic lens, or the like), the straightness of emitted electrons can be increased. The improved straightness of emitted electrons is advantageous in reducing crosstalk in a system where a number of electron emitters 10A are arrayed for use as an electron source for a display apparatus, for example.

As described above, the electron emitter 10A is easily capable of producing high electric field concentrations. The electron emitter 10A is also capable of increasing the number of electron emission regions, achieving high output and high efficiency for emitting electrons, and being driven at a low voltage (low power consumption).

With the electron emitter 10A, in particular, at least the upper surface of the emitter element 12 has irregularities 22 produced by grain boundaries of the dielectric material, and the upper electrode 14 has through regions 20 corresponding respectively to recesses 24 of the grain boundaries of the dielectric material. The eaves 26 of the upper electrode 14 can thus easily be realized.

The maximum angle θ formed between the upper surface of the emitter element 12, i.e., the surface of each of the lands 30 (the inner wall surface of each of the recesses 24) produced by the grain boundaries of the dielectric material, and the lower surface 26a of the eave 26 of the upper electrode 14 is in the range of 1°≦θ≦60°, and the maximum distance d in the vertical direction between the surface of each of the lands 30 (the inner wall surface of each of the recesses 24) produced by the grain boundaries of the dielectric material of the emitter element 12 and the lower surface 26a of the eave 26 of the upper electrode 14 is in the range of 0 μm≦d≦10 μm. With these structural details, the degree of an electric field concentration at the gap 28 is made greater for achieving high output and high efficiency for emitting electrons and lowering the drive voltage.

With the electron emitter 10A, each of the through regions 20 has the shape of the hole 32. As shown in FIG. 2, portions of the emitter element 12 whose polarization is reversed or changed depending on the drive voltage Va that is applied between the upper electrode 14 and the lower electrode 16 (see FIG. 1) include portions (first portions) 40 directly below the upper electrode 14, and portions (second portions) 42 corresponding to regions extending from inner peripheral edges of the through regions 20 inwardly into the through regions 20. Particularly, the second portions 42 change depending on the level of the drive voltage Va and the degree of the electric field concentration. With the electron emitter 10A, therefore, the average diameter of the holes 32 is in the range from 0.1 μm to 10 μm. As long as the average diameter falls in the above range, a distribution of electrons emitted through the through regions 20 is almost free of variations, allowing electrons to be emitted efficiently.

If the average diameter of the holes 32 is less than 0.1 μm, then the regions where electrons are accumulated are reduced, and the amount of emitted electrons is also reduced. While one solution would be to form many holes 32, it would be difficult and costly to form many holes 32. If the average diameter of the holes 32 exceeds 10 μm, then the proportion (share) of the portions (second portions) 42 which contribute to the emission of electrons, of those areas of the emitter element 12 which are exposed through the through regions 20, is reduced, resulting in a reduction in the efficiency with which to emit electrons.

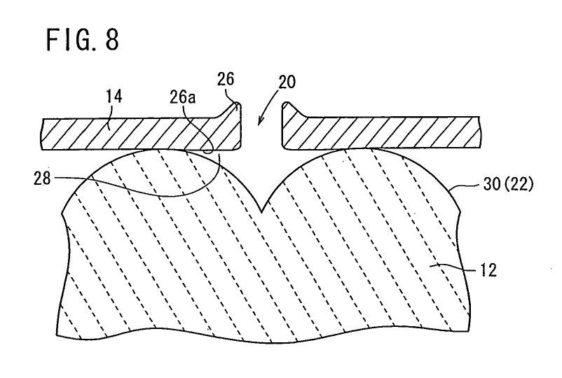

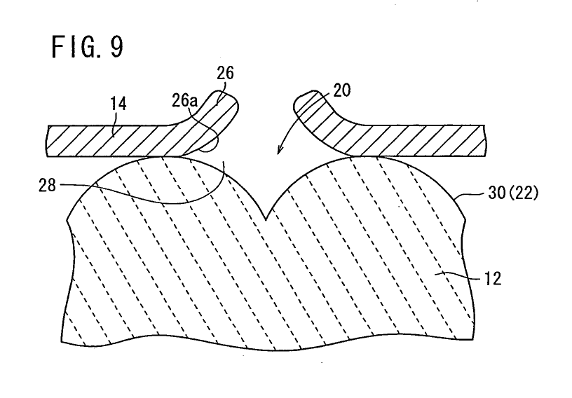

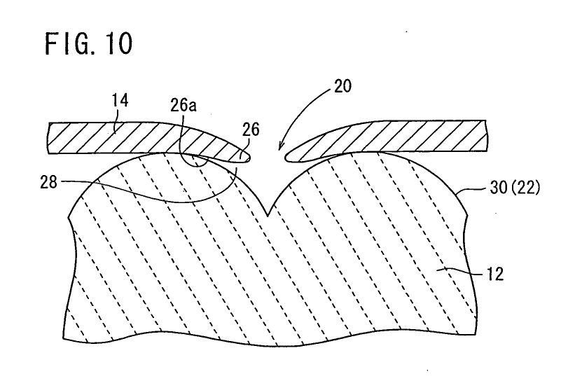

The eave 26 of the upper electrode 14 may have a cross-sectional shape whose upper and lower surfaces extend horizontally, as shown in FIG. 2. Alternatively, as shown in FIG. 8, the eave 26 may have a lower surface 26a lying substantially horizontally and an upper end raised upwardly. Alternatively, as shown in FIG. 9, the eave 26 may have a lower surface 26a gradually inclined upwardly toward the center of the through region 20. As shown in FIG. 10, the eave 26 may have a lower surface 26a gradually inclined downwardly toward the center of the through region 20. The example shown in FIG. 8 is capable of improving the function of the eave 26 as a gate electrode, and the example shown in FIG. 10 allows an electric field concentration to occur easily for achieving high output and high efficiency for emitting electrons because the gap 28 is narrowed.

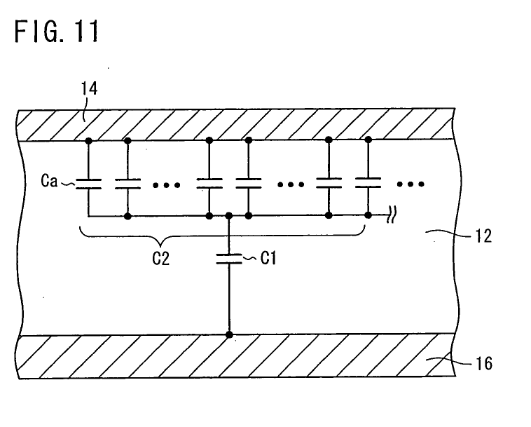

As shown in FIG. 11, the electron emitter 10A comprises an electrical capacitor C1 produced by the emitter element 12 and a cluster of electrical capacitors Ca produced by the respective gaps 28, between the upper electrode 14 and the lower electrode 16. The capacitors Ca produced by the respective gaps 28 are expressed as a single capacitor C2 representative of a parallel connection of the capacitors Ca. In terms of an equivalent circuit, the electron emitter 10A is represented by a series-connected circuit of the capacitor C2 provided by a cluster of capacitors and the capacitor C1 provided by the emitter element 12.

Actually, the capacitor C1 provided by the emitter element 12 is not connected in series to the capacitor C2 provided by a cluster of capacitors, but series-connected capacitive components vary depending on the number of through regions 20 formed in the upper electrode 14 and the overall area of the formed through regions 20.

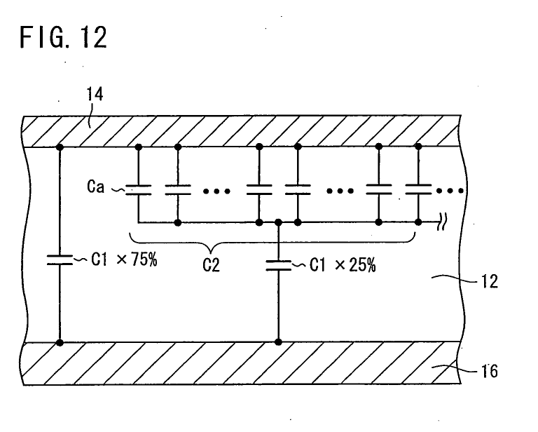

As shown in FIG. 12, capacitances will be calculated on the assumption that 25% of the capacitor C1 provided by the emitter element 12 is connected in series to the capacitor C2 provided by a cluster of capacitors. Since the gaps 28 are in vacuum, their specific dielectric constant is 1. It is assumed that the maximum distance d across the gap 28 is 0.1 μm, each gap 28 has an area S=1 μm×1 μm, and the number of gaps 28 is 10,000. It is also assumed that the emitter element 12 has a specific dielectric constant of 2000 and a thickness of 20 μm, and the upper electrode 14 and the lower electrode 16 have a confronting area of 200 μm×200 μm. The capacitor C2 provided by a cluster of capacitors has a capacitance of 0.885 pF, and the capacitor C1 provided by the emitter element 12 has a capacitance of 35.4 pF. If the part of the capacitor C1 provided by the emitter element 12 which is connected in series to the capacitor C2 provided by a cluster of capacitors is 25% of the entire capacitor C1, then the series-connected part of the capacitor C1 has a capacitance (including the capacitance of the capacitor C2 provided by a cluster of capacitors) of 0.805 pF, and the remaining capacitance is 26.6 pF.

Since the series-connected part of capacitor C1 and the remaining part are connected parallel to each other, the overall capacitance is 27.5 pF. This capacitance is 78% of the capacitance 35.4 pF of the capacitor C1 provided by the emitter element 12. Therefore, the overall capacitance is smaller than the capacitance of the capacitor C1 provided by the emitter element 12.

The capacitance of the cluster of the capacitors Ca provided by the gaps 28 is relatively small, and because of the voltage division between the capacitor C2 and the capacitor C1 provided by the emitter element 12, most of the voltage Va is applied across the gaps 28, achieving higher output for emitting electrons at the gaps 28.

Since the capacitor C2 provided by a cluster of capacitors is connected in series to the capacitor C1 provided by the emitter element 12, the overall capacitance is smaller than the capacitance of the capacitor C1 provided by the emitter element 12. Accordingly, the electron emitter 10A provides such preferable characteristics that it emits electrons at high output and has reduced overall power consumption.

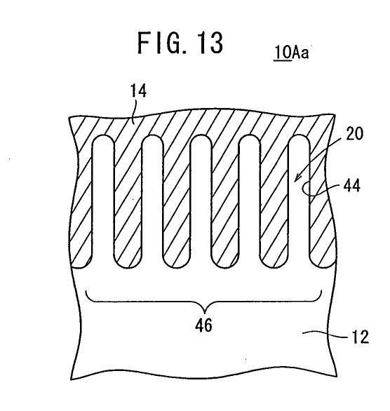

Three modifications of the electron emitter 10A described above will be described below with reference to FIGS. 13 through 15.

As shown in FIG. 13, an electron emitter 10Aa according to a first modification differs in that the shape of the through regions 20, particularly the shape as viewed from above, has the shape of notches 44. Preferably, the shape of notches 44 comprises a shape of comb-toothed notch 46 made up of a number of successive notches 44. The shape of comb-toothed notch 46 is advantageous in that it can reduce variations in a distribution of electrons emitted through the through regions 20, and allows electrons to be emitted efficiently. Particularly, the average width of the notches 44 should preferably be in the range from 0.1 μm to 10 μm. The average width represents the average of the lengths of a plurality of different line segments that extend perpendicularly to a central line of the notch 44.

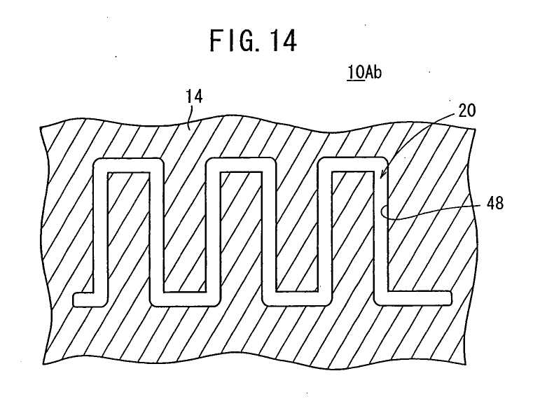

As shown in FIG. 14, an electron emitter 10Ab according to a second modification differs in that the shape of the through regions 20, particularly the shape as viewed from above, has the shape of a slit 48. The slit 48 refers to a hole which is at least 10 times longer in the direction of a longer axis (longitudinal direction) than in the direction of a shorter axis (transverse direction). Therefore, a hole whose length in the direction of a longer axis (longitudinal direction) is less than 10 times smaller than the length in the direction of a shorter axis (transverse direction) can be defined as a hole 32 (see FIG. 3). The slit 48 may be in the form of a plurality of holes 32 that communicate with each other. The average width of the slit 48 should preferably be in the range from 0.1 μm to 10 μm because it is advantageous in that it can reduce variations in a distribution of electrons emitted through the through regions 20, and allows electrons to be emitted efficiently. The average width represents the average of the lengths of a plurality of different line segments that extend perpendicularly to a central line of the slit 48.

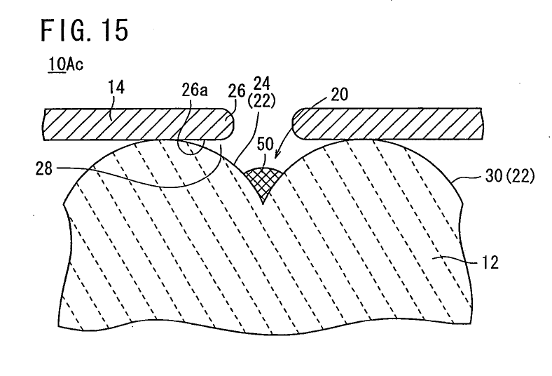

As shown in FIG. 15, an electron emitter 10Ac according to a third modification differs in that a floating electrode 50 is present in a region of the upper surface of the emitter element 12 which corresponds to each through region 20, e.g., in a recess 24 produced by a grain boundary of the dielectric material. Since the floating electrode 50 serves as an electron supply source, the electron emitter 10Ac can emit many electrons through the through regions 20 in an electron emission stage (the second output period T2 (see FIG. 4) according to the first electron emission process).

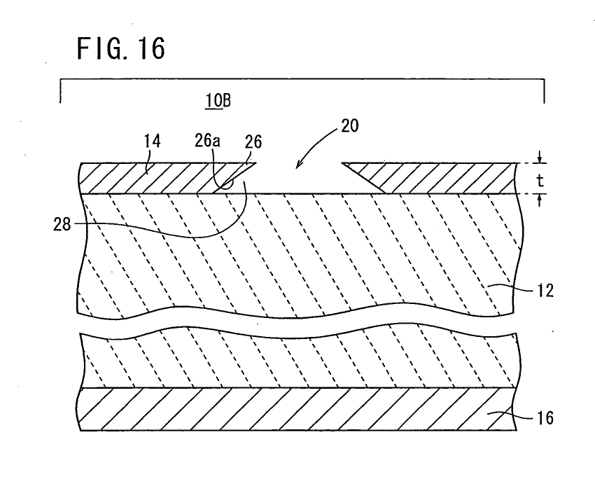

An electron emitter 10B according to a second embodiment will be described below with reference to FIG. 16.

As shown in FIG. 16, the electron emitter 10B is substantially similar in structure to the electron emitter 10A described above, but differs therefrom in that the upper electrode 14 is made of the same material as the lower electrode 16, the upper electrode 14 has a larger thickness of 10 μm, and the through regions 20 are manually formed by etching (wet etching or dry etching), lift-off, laser, or the like. The shape of each of the through regions 20 may be the shape of the hole 32, the shape of the notch 44, or the shape of the slit 48, as with the electron emitter 10A described above.

The lower surface 26a of the peripheral edge 26 of each of the through regions 20 of the upper electrode 14 is gradually inclined upwardly toward the center of the through region 20. This configuration of the lower surface 26a can simply be produced by using lift-off, for example.

The electron emitter 10B can easily produce a high electric field concentration as with the electron emitter 10A described above. The electron emitter 10B also has an increased number of electron emission regions, can achieve high output and high efficiency for emitting electrons, and can be driven at a low voltage (low power consumption).

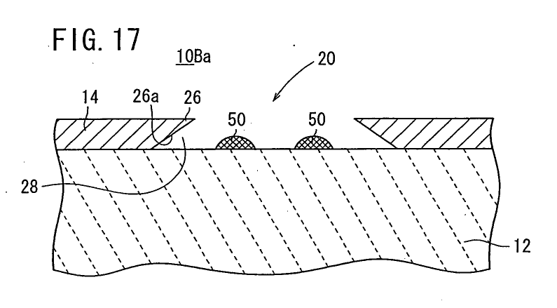

FIG. 17 shows an electron emitter 10Ba according to a first modification. With the electron emitter 10Ba, floating electrodes 50 are formed on an upper surface of the emitter element 12 which corresponds to each of the through regions 20.

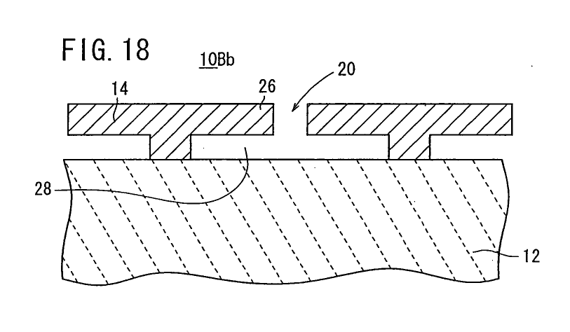

FIG. 18 shows an electron emitter 10Bb according to a second modification. With the electron emitter 10Bb, an upper electrode 14 comprises an electrode having a substantially T-shaped cross section.

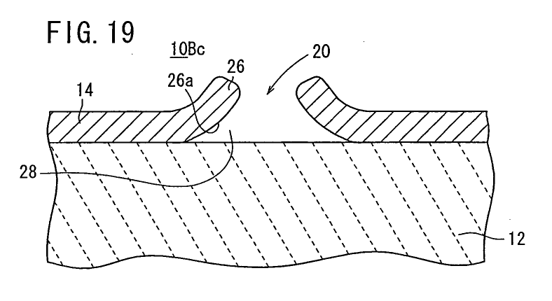

FIG. 19 shows an electron emitter 10Bc according to a third modification. With the electron emitter 10Bc, an upper electrode 14 has such a shape that the peripheral edge 26 of each of the through regions 20 of the upper electrode 14 is raised. The upper electrode 14 may be thus shaped by including a material, which will be gasified in a baking process, in the film material of the upper electrode 14. In the baking process, the included material is gasified, leaving a number of through regions 20 in the upper electrode 14 with the peripheral edges 26 thereof being raised.

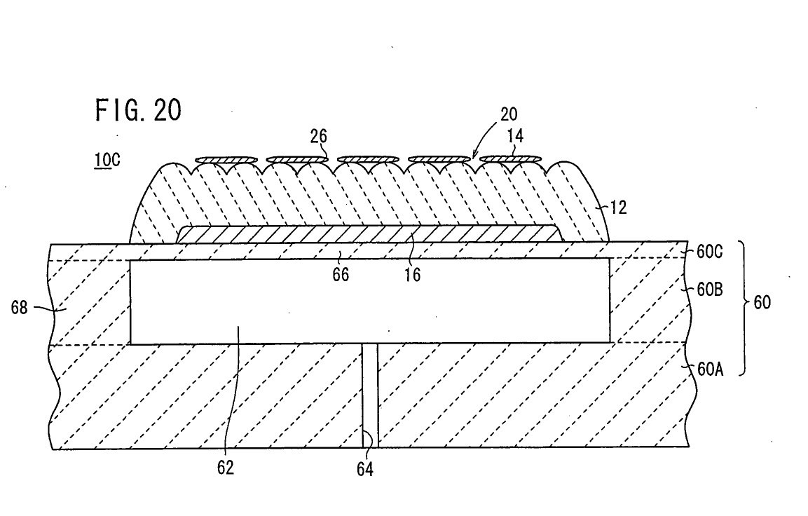

An electron emitter 10C according to a third embodiment will be described below with reference to FIG. 20.

As shown in FIG. 20, the electron emitter 10C is substantially similar in structure to the electron emitter 10A described above, but differs therefrom in that it has a single board 60 made of ceramics, a lower electrode 16 is formed on the board 60, an emitter element 12 is formed on the board 60 to cover the lower electrode 16, and an upper electrode 14 is formed on the emitter element 12.

The board 60 has a cavity 62 defined therein at a position corresponding to the region where each emitter element 12 is formed, for producing a thin-walled portion as described later on. The cavity 62 communicates with the exterior through a small-diameter through hole 64 that is defined in an end face of the board 60.

Of the board 60, the portion in which the cavity 62 is defined has a thin wall (hereinafter referred to as a thin-walled portion 66), and the other portion has a thick wall that functions as a fixed portion 68 supporting the thin-walled portion 66.

Specifically, the board 60 is in the form of a laminated body comprising a board layer 60A as a lowermost layer, a spacer layer 60B as an intermediate layer, and a thin-walled layer 60C as an uppermost layer, and can be recognized as an integral structural body having the cavity 62 defined in the portion of the spacer layer 60B which corresponds to the emitter element 12. The board layer 60A functions as a reinforcing board and also as a wiring board. The board 60 may be produced by integrally sintering the board layer 60A, the spacer layer 60B, and the thin-walled layer 60C, or bonding these layers 60A through 60C.

The thin-walled portion 66 should preferably be made of a highly heat-resistant material for the following reasons: If the emitter element 12 is directly supported on the thin-walled portion 66 by the fixed portion 68 without using a material which has poor heat resistance, such as an organic adhesive or the like, then the thin-walled portion 66 should preferably be made of a highly heat-resistant material in order to prevent the thin-walled portion 66 from being modified at least when the emitter element 12 is formed.

The thin-walled portion 66 should preferably be made of an electrically insulating material in order to electrically separate interconnections formed on the board 60 and leading to the upper electrode 14 and interconnections leading to the lower electrode 16 from each other.

The thin-walled portion 66 may be made of a highly heat-resistant metal or a material such as an enameled material where a surface of such a highly heat-resistant metal is covered with a ceramic material such as glass or the like. However, ceramics is most favorable as the material of the thin-walled portion 66.

The ceramics of the thin-walled portion 116 may be stabilized zirconium oxide, aluminum oxide, magnesium oxide, titanium oxide, spinel, mullite, aluminum nitride, silicon nitride, glass, or a mixture thereof. Of these materials, aluminum oxide and stabilized zirconium oxide are preferable from the standpoint of mechanical strength and tenacity. Stabilized zirconium oxide is particularly preferable because it has relatively high mechanical strength, relatively high tenacity, and causes a relatively small chemical reaction with the upper electrodes 14 and the lower electrodes 16. Stabilized zirconium oxide includes both stabilized zirconium oxide and partially stabilized zirconium oxide. Stabilized zirconium oxide does not cause a phase transition because it has a crystalline structure such as a cubic structure or the like.

Zirconium oxide causes a phase transition between a monoclinic structure and a tetragonal structure at about 1000° C., and may crack upon such a phase transition. Stabilized zirconium oxide contains 1-30 mol % of a stabilizer such as calcium oxide, magnesium oxide, yttrium oxide, scandium oxide, ytterbium oxide, cerium oxide, or an oxide of a rare earth metal. The stabilizer should preferably contain yttrium oxide in order to increase the mechanical strength of the board 60. The stabilizer should preferably contain 1.5 to 6 mol % of yttrium oxide, or more preferably 2 to 4 mol % of yttrium oxide, and furthermore should preferably contain 0.1 to 5 mol % of aluminum oxide.

The crystalline phase may be a mixture of cubic and monoclinic systems, a mixture of tetragonal and monoclinic systems, or a mixture of cubic, tetragonal and monoclinic systems. Particularly, a tetragonal system or a mixture of tetragonal and cubic systems is most preferable as a major crystalline phase from the standpoint of strength, tenacity, and durability.

If the board 60 is made of ceramics, then it is constructed of relatively many crystal grains. In order to increase the mechanical strength of the board 60, the average diameter of the crystal grains should preferably be in the range from 0.05 to 2 μm and more preferably in the range from 0.1 to 1 μm.

The fixed portion 68 should preferably be made of ceramics. The fixed portion 68 may be made of the same ceramics as the thin-walled portion 66 or ceramics different from the thin-walled portion 66. As with the material of the thin-walled portion 66, the ceramics of the fixed portion 68 may stabilized zirconium oxide, aluminum oxide, magnesium oxide, titanium oxide, spinel, mullite, aluminum nitride, silicon nitride, glass, or a mixture thereof.

In particular, the board 60 used in the electron emitter 10C should preferably made of a material which includes zirconium oxide as a chief component, a material which includes aluminum oxide as a chief component, or a material which includes a mixture of zirconium oxide and aluminum oxide as a chief component. Of these materials, the material which includes zirconium oxide as a chief component is preferable.

Clay or the like may be added as a sintering additive. Additive components need to be adjusted so that materials which can easily be vitrified, such as silicon oxide, boron oxide, etc. will not excessively be contained. These easily vitrifiable materials are advantageous from the standpoint of joining the board 60 and the emitter element 12, but promote a reaction between the board 60 and the emitter element 12 and make it difficult to keep a desired composition of the emitter element 12, resulting in poor device characteristics.

Specifically, silicon oxide, etc. contained in the board 60 should be limited to 3 weight % or less, or preferably 1 weight % or less. The chief component described above refers to a component which is present in 50 weight % or more.

The thin-walled portion 66 and the emitter element 12 should preferably be of thicknesses on the same level. If the thickness of the thin-walled portion 66 were much greater than (one or more digits different from) the thickness of the emitter element 12, then since the thin-walled portion 66 would act to prevent the emitter element 12 from shrinking upon sintering, stresses at the interface between the emitter element 12 and the board 60 would be increased, tending to cause the emitter element 12 and the board 60 to peel off each other. Conversely, if the thicknesses of the thin-walled portion 66 and the emitter element 12 are on the same level, then since the board 60 (the thin-walled portion 66) finds it easy to follow the shrinkage of the emitter element 12 upon sintering, they can appropriately be integrally combined. Specifically, the thickness of the thin-walled portion 66 should preferably in the range from 1 to 100 μm, more preferably in the range from 3 to 50 μm, and much more preferably in the range from 5 to 20 μm. The thickness of the emitter element 12 should preferably in the range from 5 to 100 μm, more preferably in the range from 5 to 50 μm, and much more preferably in the range from 5 to 30 μm.

The emitter element 12 may be formed on the board 60 by any of various thick-film forming processes including screen printing, dipping, coating, electrophoresis, etc., or any of various thin-film forming processes including an ion beam process, sputtering, vacuum evaporation, ion plating, chemical vapor deposition (CVD), plating, etc.

The electron emitter 10C may be sintered by stacking a material serving as the lower electrode 16, a material serving as the emitter element 12, and a material serving as the upper electrode 14 successively on the board 60 and baking them as an integral structure, or heating (baking) the lower electrode 16, the emitter element 12, and the upper electrode 14 each time one of them is formed, to make them integral with the board 60. Depending on the process by which the upper electrode 14 and the lower electrode 16 are formed, they may not be heated (sintered) so as to be integrally combined.

The sintering process for integrally combining the board 60, the emitter element 12, the upper electrode 14, and the lower electrode 16 with the board 60 may be carried out at a temperature ranging from 500 to 1400° C., preferably from 1000 to 1400° C. For heating the emitter element 12 which is in the form of a film, the emitter element 12 should be sintered together with its evaporation source while their atmosphere is being controlled, so that the composition of the emitter element 12 will not become unstable at the high temperature.

The emitter element 12 may be covered with an appropriate member for concealing the surface thereof against direct exposure to the sintering atmosphere when the emitter element 12 is sintered. The covering member may be made of the same material as the board 60.

With the electron emitter 10C, when the emitter element 12 is baked, it shrinks, and stresses produced when the emitter element 12 shrinks are released by a deformation of the cavity 62. Therefore, the emitter element 12 is made sufficiently dense. As the densification of the emitter element 12 increases, the withstand voltage thereof also increases, and the polarization thereof is reversed and changed efficiently, resulting in increased characteristics of the electron emitter 10C.

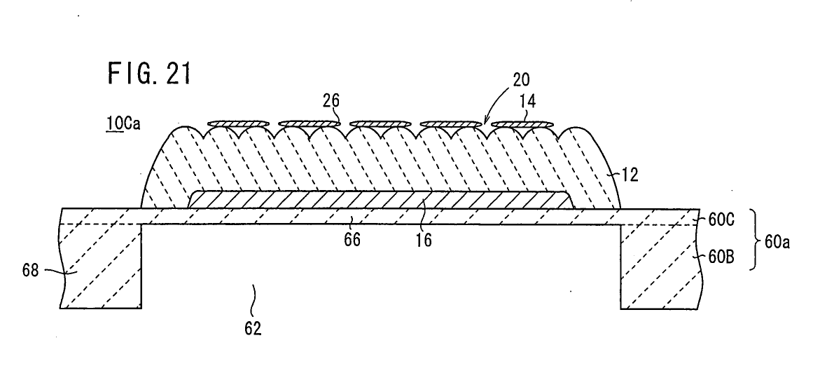

With the electron emitter 10C, the board 60 comprises a board having a three-layer structure. However, as with an electron emitter 10Ca according to a modification shown in FIG. 21, a board 60a having a two-layer structure where the board layer 60A as the lowermost layer is dispensed with may be employed.

The electron emitter according to the present invention is not limited to the above embodiments, but may employ various arrangements without departing from the gist of the invention.

1. An electron emitter comprising:
an emitter element made of a dielectric material;
a first electrode formed on a first surface of said emitter element; and
a second electrode formed on a second surface of said emitter element,
wherein a drive voltage is applied between said first electrode and said second electrode for emitting electrons from said emitter element;
at least said first electrode has a plurality of through regions, and said emitter element is exposed through said through regions; and
said first electrode has a peripheral surface around each of said through regions, said peripheral surface facing said emitter element and spaced from said emitter element.

2. An electron emitter according to claim 1, wherein at least said first surface of said emitter element has an uneven surface defined by grain boundaries of a dielectric material, and said through regions of said first electrode are formed at positions corresponding to recesses of said uneven surface.

3. An electron emitter according to claim 1, wherein a maximum angle θ formed between said first surface of said emitter element and said peripheral surface around each of said through regions facing said emitter element is in the range of 1°≦θ≦60°.

4. An electron emitter according to claim 1, wherein a maximum distance d in a vertical direction between said first surface of said emitter element and said peripheral surface around each of the through regions facing said emitter element is in the range of 0 μm<d≦10 μm.

5. An electron emitter according to claim 1, wherein floating electrodes are present on said first surface of said emitter element, at positions corresponding to said through regions.

6. An electron emitter according to claim 1, wherein said through regions comprise holes.

7. An electron emitter according to claim 6, wherein said holes have an average diameter ranging from 0.1 μm to 10 μm.

8. An electron emitter according to claim 1, wherein said through regions comprise notches.

9. An electron emitter according to claim 8, wherein said through regions comprise comb-toothed notches.

10. An electron emitter according to claim 8, wherein said notches have an average width ranging from 0.1 μm to 10 μm.

11. An electron emitter according to claim 1, wherein said through regions comprise slits having an arbitrary shape.

12. An electron emitter according to claim 11, wherein said slits have an average width ranging from 0.1 μm to 10 μm.

13. An electron emitter comprising:
an emitter element made of a dielectric material;
a first electrode in contact with a first surface of said emitter element;
a second electrode in contact with a second surface of said emitter element;
at least said first electrode has a plurality of through regions, and said emitter element is exposed through said through regions;
said emitter element produces an electrical condenser, and said through regions of said first electrode produce a cluster of plural electrical capacitors between said first electrode and said emitter element.
